(19) United States
(12) Patent Application Publication
(10) Pub. No.: US 2007/0203800 A1
(43) Pub. Date: Aug. 30, 2007

(54) Method for protecting equity in purchased goods

(76) Inventor: Leon P. Opyd III, Coal City, IL (US)

Correspondence Address: CHERSKOV & FLAYNIK;the Civic Opera Building, Suite 1447, 20 N. Wacker Drive, Chicago, IL, 60606, US

(21) Appl. No.: 11/363,112

(22) Filed: Feb. 27, 2006

(51) Int. Cl. G06Q 30/00

(52) U.S. Cl. 705/26

(57) ABSTRACT

A method 10 for protecting equity in purchased goods that are disposed of during a predetermined time period after purchase, includes establishing the purchase date and price for the purchased goods 14, determining a purchaser's equity in the purchased goods on the purchase date 16, selecting a time period for protecting the purchaser's equity in the purchase goods 18, determining a purchaser's equity in the purchased goods on a disposition date for the purchased goods 26, calculating the difference between the purchaser's equity and a fair market value for the purchased goods on the disposition date 30, and paying the purchaser a computer determined amount when the purchaser's equity is greater than the fair market value for the purchased goods on the disposition date 32, 40 and 42.

### BACKGROUND OF THE INVENTION

1. Field of the Invention

The present invention relates to protecting equity in purchased goods, and more particularly, to protecting the downpayment for procuring possession of a purchased vehicle during a predetermined time period.

2. Background of the Prior Art

A purchaser of goods, vehicles in particular, typically pays a downpayment and procures financing to complete the purchase transaction and procure possession of the goods or vehicle on the date of sale. The purchaser's downpayment is usually the purchaser's equity in the purchased products; although, the purchaser's equity can be greater or less than the downpayment when purchasing products with unknown or difficult to determine fair market values. Generally, an insurance policy (“Gap Insurance”) is also procured on the sales date to obtain possession of the goods or vehicle. An up-front one time payment is made by the purchaser to procure the Gap Insurance policy which protects the finance company and/or purchaser in the event that the goods or vehicle are damaged. When the goods or vehicle are damaged such that the cost of repair is greater than the fair market value of the goods or vehicle, the Gap Insurance pays the finance company a dollar amount equal to the loan balance minus the fair market value of the goods or vehicle in an undamaged condition on the date of damage.

A problem occurs when the goods or vehicle depreciate relatively fast after purchase, and the goods or vehicle become damaged, lost, stolen or sold within a relatively short time period after purchase, resulting in a substantially reduced fair market value for the goods or vehicle. The depreciation of the goods or vehicle results in the purchaser losing a corresponding portion of his or her downpayment when payments are received to compensate the purchaser for the loss of the goods or vehicle. Thus, the purchaser is forced to raise more funds to purchase a replacement vehicle or goods that, from the purchaser's perspective, perform the same function and are of equal value, from the purchaser's viewpoint, to the original products. These common results pertaining to damaged, lost, stolen or sold goods or vehicles are unfair to the purchaser.

A need exists for a method for protecting, on the purchase date, the purchaser's downpayment and/or equity in the purchased goods or vehicle in the event that the goods or vehicle are damaged, lost, stolen or sold. The method must allow the purchaser to select on the purchase date, a time period to protect his or her equity in the purchased goods or vehicle. Further, the method must allow the purchaser to determine on the purchase date, a reasonable amount of money that he or she will receive for any day during the selected time period that the goods or vehicle are lost, stolen, damaged or sold. Also, the method must provide the parameters for procuring an insurance policy for the purchaser's benefit to guarantee the amount of money the purchaser is to receive in the event the goods or vehicle are damaged, stolen, lost or sold during the selected time period.

### SUMMARY OF THE INVENTION

It is an object of the present invention to overcome many of the disadvantages associated with protecting equity in purchased goods that are damaged with a predetermined time period after purchase. It is another object of the present invention to overcome many of the disadvantages associated with protecting equity and/or downpayment in purchased vehicles that depreciate in value relatively quickly after purchase.

A principal object of the present invention is to provide a method that allows a purchaser of goods to determine his or her equity in the purchased goods on the purchase date. A feature of the method is that the purchaser's equity in the purchased goods determined on the purchase date, is negotiated between the purchaser and an insurance company, the insurance ultimately issuing an insurance policy that guarantees the determined purchaser's equity in the purchased goods. An advantage of the method is that the dollar amount of the determined purchaser's equity in the purchased goods is based on a reasonable value that the goods provide to the purchaser rather than a typical fair market value.

Another object of the present invention is to provide a method that allows a purchaser on the purchase date of the goods to select a time period for protecting the determined purchaser's equity in the purchased goods. A feature of the method is that on the purchase date of the goods, the purchaser's equity in the purchased goods is set for a time period that the purchaser excepts to own the purchased goods. An advantage of the method is that the purchaser's equity in the purchased goods is not reduced over time due to depreciation parameters.

Another object of the present invention is to provide a method that determines a purchaser's equity in the purchased goods on a damage or sales date for the purchased goods. A feature of the method is that on the purchase date of the goods, the purchaser's equity in the purchased goods is determined for each day of the selected time period. An advantage of the method is that on the purchase date of the goods, the purchaser knows the dollar amount he or she will receive for the purchased goods in the event the purchased goods are sold or damaged during the selected time period.

Another object of the present invention is to provide a method that calculates the difference between the purchaser's equity and a fair market value for the purchased goods on the damage or sales date. A feature of the method is that a computer ultimately determines the purchaser's equity in the purchased goods based upon a negotiated amount between the purchaser and an insurance company, or is based upon an algorithm agreed upon by purchaser and insurance company, then entered into the computer. Another feature of the method is that a fair market value for the purchased goods on a damage or sales date is entered into the computer. An advantage of the method is that the computer quickly determines the dollar amount the purchaser is to be paid based upon the purchaser's equity in the purchased goods on the damage or sales date of the purchased goods.

Briefly, the invention provides a method for protecting equity in purchased goods that re damaged within a predetermined time period after purchase, said method comprising the step of establishing the purchase date and price for the purchased goods; determining a purchaser's equity in the purchased goods on the purchase date; selecting a time period for protecting said purchaser's equity in the purchased goods; determining a purchaser's equity in the purchased goods on a damage, lost, stolen or sales date for the purchased goods; calculating the difference between said purchaser's equity and a fair market value for the purchased goods on the damage or sales date; and paying the purchaser a computer determined amount when said purchaser's equity is greater than the fair market value for the purchased goods on the damage or sales date.

The invention further provides a method for maintaining equity in a vehicle for a predetermined time period after purchasing the vehicle, said method comprising the steps of recording the purchase date and price of the vehicle; recording the amount paid by a purchaser of the vehicle on the purchase date; determining a time period for maintaining a purchaser's equity in the vehicle; calculating said purchaser's equity for the vehicle on a selected day during said time period; and paying the purchaser a computer determined amount.

The invention further provides a method for insuring a purchaser's downpayment when purchasing a vehicle, said method comprising the steps of entering vehicle purchase parameters into a computer; entering a vehicle ownership time period into said computer; calculating via said computer, a purchaser's equity in the vehicle over said ownership time period; and paying an insurance premium to an insurance company to insure said calculated purchaser's equity in the vehicle over said ownership time period whereby the purchaser receives a payment from the insurance company in the event that the fair market value of the vehicle is insufficient for the purchaser to receive a calculated equity on a date, within said ownership time period, that the vehicle is sold, lost, stolen or damaged.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a flow chart depicting a method for protecting equity in purchased goods that are damaged or sold within a predetermined time period after purchase.

### DESCRIPTION OF THE PREFERRED EMBODIMENT

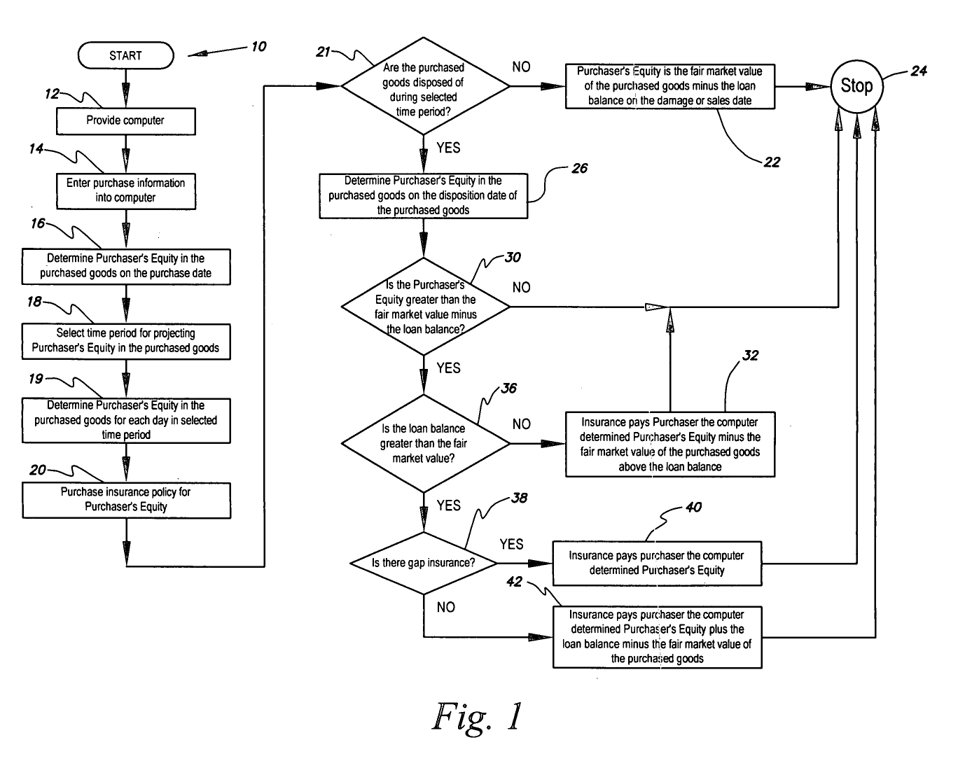

Referring now to the flow chart of FIG. 1, a method for protecting equity or a purchaser's downpayment in purchased goods that are damaged, lost, stolen or sold within a predetermined time period after purchase is denoted by numeral 10. The purchaser's downpayment includes but is not limited to cash, rebates, trade items “trade-ins,” services, leases or combinations thereof. More specifically, the method 10 protects the purchaser's downpayment from being lost or reduced due to depreciation of the purchased goods over a relatively short period of time. Typically, when goods, especially vehicles, are purchased, the depreciation can cause the fair market value (which is determined via methods well known to those of ordinary skill in the art) of the vehicle to be less than the amount required to finance the purchase. Generally, an insurance policy is procured that protects (irrespective of depreciation) a finance company's loan amount required to purchase the vehicle, however, there is no insurance policy in place that protects the purchaser's equity or downpayment.

Referring now to block 12, a computer is utilized to receive information pertaining to purchased goods, and in particular, to information pertaining to a purchased vehicle. The computer can be a desk-top or lap-top, both well known to those of ordinary skill in the art. Information pertaining to the purchased goods, is entered into the computer pursuant to block 14, the information includes parameters that represent the goods fair market value. For a purchased vehicle, information or parameters representing fair market value that are “fed” into the computer includes but is not limited to the year, make and model number of the vehicle, and the mileage, condition and general performance of the vehicle.

After providing information pertaining to purchased goods to the computer, the purchaser determines his or her equity in the purchased goods on the purchase date pursuant to block 16. Generally, the purchaser's equity in the purchased goods on the day of purchase will be the fair market value of the purchased goods minus the loan or financing required to purchase the goods, which should equal the downpayment the purchaser advances to the seller for possession of the purchased goods. However, if the purchased goods have a fair market value greater or lower than the downpayment added to the funds borrowed to purchase the goods, then the purchaser's equity in the purchased goods will be correspondingly greater or lower than the downpayment. Irrespective of the fair market value of the purchased goods at the time of purchase, the objective is to establish the purchaser's equity in the purchased goods at the time of purchase at a dollar amount equal to or greater than the downpayment. The purchaser's equity at the time of purchase is entered into the computer.

Referring now to block 18, a time period is selected for protecting equity in the purchased goods, the time period being entered into the computer. The time period is provided by the purchaser and is based upon an estimated time period that the purchaser expects to own the purchased goods, or is based upon a time period corresponding to the useful life of the purchased goods, or is set via negotiations between the purchaser and an insurance company. After selecting a time period for protecting equity in the purchased goods, the purchaser's equity in the purchased goods is determined for each day during the selected time period thereby establishing a constant or time varying equity dollar amount for the purchased goods in the event the goods are damaged, lost, stolen or sold during the selected time period (block 19).

Referring now to block 20, the purchaser then pays a one time “up-front” insurance premium to the insurance company for an insurance policy to insure the purchaser's equity in the purchased goods over the selected time period, whereby the purchaser receives a payment from the insurance company in the event that the fair market value of the purchased goods or vehicle is insufficient for the purchaser to receive a predetermined or established equity dollar amount on a date, within the time period, that the purchaser disposes of the purchased goods.

Referring to decision block 21, if the purchaser maintains ownership of the purchased goods in an undamaged condition for a time period greater than the selected time period, then the purchaser's equity in the purchased goods equals the fair market value minus the loan balance of the purchased goods (block 22), and the method for protecting the purchaser's equity in the purchased goods terminates (block 24).

Returning to decision block 21, if the purchased goods are sold, lost, stolen or damaged before the selected time period is achieved, then the purchaser's equity in the purchased goods in an undamaged condition is determined by the computer for the date the purchased goods are sold, lost, stolen or damaged (“the disposition date”—block 26). On the day of purchase, the purchaser's equity in the purchased goods is the downpayment. Further, on the day of purchase, the purchaser decides if his or her equity in the purchased goods will have a constant value (equal to or less than the downpayment) during the entire selected time period. Alternatively, the purchaser may decide to have the equity diminish (as determined by a computer algorithm well known to those of ordinary skill in the art) during the preselected time period, whereupon, the purchaser procures a corresponding insurance policy that guarantees the decided upon equity. The purchaser's insurance premium will ultimately be based upon the purchaser's choice of equity protection for the purchased goods over the selected time period. The one time, up-front insurance premium, which may include several payments made on and/or after the purchase date, corresponds to the insurance payment that may be made by the insurance company or provider to the purchaser on a date subsequent to the vehicle purchase date.

The computer ultimately determines the equity for the purchased goods for each day within the selected time period. The computer sets the daily equity value, which may or may not decrease over time based upon an algorithm corresponding to the depreciation of the purchased goods, via a program that assigns a dollar value to the purchased goods for each day during the preselected time period; the purchaser and the insurance company having agreed to the program daily dollar amounts when the purchaser pays the up-front insurance premium.

Referring now to decision block 30, after the computer determined the purchaser's equity in the purchased goods on the damage or disposition date, if the purchaser's equity is equal to or less than the fair market value minus the loan balance of the purchased goods, then the purchaser receives the purchased good fair market value minus the loan balance, and the method 10 for protecting the purchaser's equity terminates (block 24). If the purchaser's equity is greater than the fair market value minus the loan balance (decision block 30), then the purchaser is paid by the insurance company the purchaser's equity minus the fair market value above the loan balance (block 32). In the event that the loan balance is greater than the fair market value of the purchased goods (decision block 36), a “gap” insurance policy pays off the amount of loan balance above the fair market value (decision block 38), and the insurance company pays the purchaser the computer determined purchaser's equity (block 40). If the loan balance is greater than the fair market value of the purchased goods (decision block 36) and there is no gap insurance policy (decision block 38), then the insurance company pays the purchaser the computer determined purchaser's equity plus the loan balance minus the fair market value of the purchased goods (block 42); the purchaser's net dollar amount being the purchaser's equity as determined by the computer.

In operation, a purchaser of goods (vehicles in particular) pays a downpayment predetermined up-front amount of money or value via trade, services or rebate. The purchaser requires that a predetermined portion of the money or trade value be protected over a preselected time period thereby maintaining a calculable amount of owner's equity in the purchased goods for any selected day during the preselected time period. Thus, the purchaser knows exactly what amount of money he or she will receive for the purchased goods in the event the goods are damaged or sold during the time period, irrespective of the fair market value of the purchased goods or the remaining loan balance on the goods on the damage or sales date.

The purchaser's equity or downpayment in the purchased goods that are damaged within a predetermined time period, is protected via a method 10 that includes providing a desk-top or lap-top computer 12. Information pertaining to the purchased goods is fed in the computer thereby enabling the computer to calculate the purchaser's equity in the goods on the day of purchase 16. The purchaser then selects a time period 18 for protecting his or her equity in the purchased goods. The selected time period is entered into the computer. The purchaser then determines the amount of equity to be maintained in the purchased goods for each day of the selected time period 19. The equity amount for each day during the selected time period is entered into the computer, alternatively, an algorithm for determining the equity amount for each day during the selected time period is entered into the computer. The purchaser then pays a one time up-front insurance premium 20 to an insurance company for an insurance policy to insure the purchaser's equity in the purchased goods for a predetermined amount for each day during the selected time period.

Referring to decision block 21, if the purchased goods are sold, lost, stolen or damaged after the selected time period, then the purchaser receives nothing form the insurance company and is left with the fair market value of the purchased goods minus the outstanding loan balance (block 22). If the purchased goods are sold, lost, stolen or damaged during the selected time period, then the purchasers equity in the purchased goods for the sales or damage date is determined by the computer (block 26).

After the computer determines the purchaser's equity in the purchased goods on the damage or disposition date, if the computer determined purchaser's equity is equal to or less than the fair market value minus the loan balance of the purchased goods on the damage or disposition date (decision block 30), then the purchaser receives the purchased goods fair market value minus the loan balance. More specifically, the purchaser receives no payment from the insurance company and the method of protecting the purchaser's equity stops (block 24). If the computer determined purchaser's equity is greater than the fair market value minus the loan balance on the damage or disposition date (decision block 30), then the purchaser is paid by the insurance company the computer determined purchaser's equity minus the fair market value of the purchased goods above the loan balance (block 32).

The purchaser ultimately receives their equity in the purchased goods via an insurance policy or by selling damaged goods. Proceeds from the insurance policy or the sold damaged goods are used first to pay the loan balance. The remaining proceeds are retained by the purchaser. If the loan balance is greater than the fair market value of the purchased goods (block 36), and if there is a gap insurance policy (block 38), the purchaser is paid a computer determined purchaser's equity (block 40); if there is no gap insurance policy (block 38), the purchaser is paid a computer determined purchaser's equity plus the loan balance minus the fair market value of the purchased goods (block 42).

The foregoing description is for purposes of illustration only and is not intended to limit the scope of protection accorded this invention. The scope of protection is to be measured by the following claims, which should be interpreted as broadly as the inventive contribution permits.

1. A method for protecting equity in purchased goods that are damaged within a predetermined time period after purchase, said method comprising the steps of:
establishing the purchase date and price for the purchased goods;
determining a purchaser's equity in the purchased goods on the purchase date;
selecting a time period for protecting said purchaser's equity in the purchased goods;
determining a purchaser's equity in the purchased goods on a disposition date for the purchased goods;
calculating the difference between said purchaser's equity and a fair market value for the purchased goods on the damage or sales date; and
paying the purchaser a computer determined amount when said purchaser's equity is greater than the fair market value for the purchased goods on the damage or sales date.

2. The method of claim 1 wherein said step of determining said purchaser's equity in the purchased goods on the purchase date includes the step of recording the purchaser's cash payment or trade value.

3. The method of claim 1 wherein said steps of established purchase date and price for the purchased goods, determining purchaser's equity in the purchased goods on the purchase date, and selecting a time period for protecting said purchaser's equity in the purchased goods, include the step of entering or inputting said purchase date, purchase price, purchaser's equity and time period into a computer.

4. The method of claim 1 wherein said step of determining a purchaser's equity in the purchased goods on said disposition date for the purchased goods includes the step of decreasing said purchaser's equity in the purchased goods during said selected time period.

5. The method of claim 4 wherein said step of decreasing said purchaser's equity in the purchased goods during said selected time period includes the step of decreasing said purchaser's equity upon a preselected depreciation algorithm.

6. The method of claim 1 wherein said step of determining a purchaser's equity in the purchased goods on said disposition date for the purchased goods includes the step of researching national association appraisal manuals pertaining to the purchased goods.

7. The method of claim 1 wherein said step of paying the purchaser said calculated difference includes the step of procuring an insurance policy that pays the purchaser.

8. The method of claim 7 wherein said step of procuring an insurance policy includes the step of establishing a one time insurance premium amount required to be paid to an insurance provider, said insurance premium amount corresponding to the payment amount to be paid by the insurance provider to the purchaser in the event that the purchased goods are disposed of during said selected time period and the purchaser's equity is greater than the fair market value for the purchased goods on said disposition date.

9. A method for maintaining equity in a vehicle for a predetermined time period after purchasing the vehicle, said method comprising the steps of:
recording the purchase date and price of the vehicle;
recording the amount paid by a purchaser of the vehicle on the purchase date;
determining a time period for maintaining a purchaser's equity in the vehicle;
calculating said purchaser's equity for the vehicle on a selected day during said time period; and
paying the purchaser a computer determined amount.

10. The method of claim 9 wherein the step of recording the purchase date and price of the vehicle includes the step of entering said date and price into a computer.

11. The method of claim 9 wherein the step of recording the amount paid includes the step of entering said amount paid into a computer.

12. The method of claim 9 wherein the step of determining a time period includes the step of entering a predetermined useful life time parameter for the vehicle into a computer.

13. The method of claim 9 wherein the step of calculating a value includes the step of entering an algorithm into a computer that determines a value for the vehicle at a date subsequent to the vehicle purchase date.

14 The method of claim 9 wherein the step of paying the purchaser includes the step of procuring an insurance policy that pays the purchaser the difference between said calculate value and a smaller fair market evaluation for the vehicle.

15. The method of claim 14 wherein the step of procuring an insurance policy includes the step of determining an insurance premium amount required to be paid by the purchaser to an insurance provider, said insurance premium amount corresponding to the payment amount to be made by said insurance provider to the purchaser on a date subsequent to the vehicle purchase date.

16. The method of claim 15 wherein the step of procuring an insurance policy includes the step of paying one insurance premium for the vehicle on the vehicle purchase date.

17. The method of claim 9 wherein the step of paying the purchaser includes the step of utilizing established vehicle evaluation information.

18. A method for insuring a purchaser's downpayment when purchasing a vehicle, said method comprising the steps of:
entering vehicle purchase parameters into a computer;
entering a vehicle ownership time period into said computer;
calculating via said computer, a purchaser's equity in the vehicle over said ownership time period; and
paying an insurance premium to an insurance company to insure said calculated purchaser's equity in the vehicle over said ownership time period whereby the purchaser receives a payment from the insurance company in the event that the fair market value of the vehicle is insufficient for the purchaser to receive a calculated equity on a date, within said ownership time period, that the vehicle is sold, lost, stolen or damaged.

19. The method of claim 18 wherein the step of entering vehicle purchase parameters includes the step of entering the vehicle purchase date, vehicle purchase price, amount paid by the purchaser to possess the vehicle, amount paid by a finance company to promote the purchase of the vehicle, the make of the vehicle, the year of the vehicle and the model of the vehicle.

20. The method of claim 18 wherein the step of paying an insurance premium includes the step of paying at least one insurance premium payment to insure said calculated equity in the vehicle on behalf of the purchaser over said ownership time period, said insurance premium payment being paid on and/or after the vehicle purchase date.

21. The method of claim 20 wherein the step of paying said insurance premium payment includes the step of negotiating said insurance premium payment with the insurance company.
